(19) United States
(12) Patent Application Publication
(10) Pub. No.: US 2012/0070530 A1
(43) Pub. Date: Mar. 22, 2012

(54) MOULD WITH FLAT THIMBLE

(75) Inventors: Wen-peng Gong, Tu Cheng (TW); Xiao-ping Wu, Tu Cheng (TW); Shih-hsiung Ho, Tu Cheng (TW)

(73) Assignee: Cheng Uei Precision Industry Co., LTD., Tu Cheng City (TW)

(21) Appl. No.: 12/884,425

(22) Filed: Sep. 17, 2010

(51) Int. Cl. B29C 45/40

(52) U.S. Cl. 425/556

(57) ABSTRACT

Provided is a mould with flat thimble including a mould core, a guide plate and a flat thimble. The mould core disposes a groove. The guide plate is fixedly connected to one end of the mould core and forms a through hole corresponding to the groove. The flat thimble partly passes through the through hole to be received in the groove. Wherein the through hole includes a communicating section and a guiding section expanded from one end of the communicating section along away from the groove, a pore diameter of the guiding section is larger than that of the communicating section, and the flat thimble partly passes through the communicating section and the guiding section to be received in the groove. The mould with flat thimble of the prevent invention can be fast assembled and can elongate life thereof.

### BACKGROUND OF THE INVENTION

1. Field of the Invention

The present invention relates to a mould, and more particularly to a mould with flat thimble.

2. Description of the Prior Art

A mould is used to produce plastic products, and different moulds consist of different components. The mould can vary the physical state of plastic material to obtain the necessary profile of the product. With the development of technology, the plastic product of injection molding is widely applied in the modernizing article, such as a computer, a mobile phone, an automobile, a digital camera and so on. Quality requirement for the molding product becomes more and more high, and design requirement for the mould becomes more and more strict. Because the wall thickness of the molding product becomes more and more thin, a round-head thimble cannot be suitable for use in a process of opening mould. A flat thimble is emerging because of the demand to push out the molding product from the mould. The flat thimble has become very common with the development of the mould industry.

Generally, the injection mould includes a mould core, a guide plate and a flat thimble. The mould core forms a mould cavity for molding a product. The guide plate is fixedly connected to one end of the mould core, and forms a through hole, size of which is same as that of the flat thimble. The flat thimble can pass through the through hole to contact with the mould cavity. After completion of injection molding, the mould core can be opened and the flat thimble can push out the molding product, whereby the molding product can be conveniently taken out.

But during assembling and employing the above injection mould, the flat thimble needs to pass through the through hole of the guide plate to be close to the mould cavity. If the flat thimble is slightly inclined to be inserted into the through hole, a front end of the flat thimble will be bumped on an inner wall of the through hole. The inner wall of the through hole can prevent the flat thimble from continuing to be close to the mould cavity, so that largely reducing the assembly efficiency of the mould and making the assembly process waste time and energy. Moreover, if the flat thimble still goes toward the mould cavity, the front end of the flat thimble and the inner wall of the through hole may be destroyed so that reducing life of the mould.

### BRIEF SUMMARY OF THE INVENTION

An object of the present invention is to provide a mould with flat thimble, which can be fast assembled and can elongate life of the mould.

To achieve the above object, in accordance with the present invention, a mould with flat thimble is provided, comprising a mould core, a guide plate and a flat thimble. The mould core disposes a groove. The guide plate is fixedly connected to one end of the mould core and forms a through hole corresponding to the groove. The flat thimble partly passes through the through hole to be received in the groove. Wherein the through hole includes a communicating section and a guiding section expanded from one end of the communicating section along away from the groove, a pore diameter of the guiding section is larger than that of the communicating section, and the flat thimble partly passes through the communicating section and the guiding section to be received in the groove.

As described above, the pore diameter of the guiding section of the mold the prevent invention is larger than that of the communicating section, and the flat thimble partly passes through the communicating section and the guiding section to be received in the groove. When the flat thimble passes through the through hole of the guide plate to be close to the mould cavity, a front portion of the flat thimble passes through the communicating section until arriving the mould cavity under the guiding of the guide plate. During the inserting of the flat thimble, the front portion cannot be blocked, but be smoothly inserted along the inner walls of the guiding section and the communicating section. Therefore, the flat thimble can be fast and exactly inserted into the through hole and contact with the mould cavity thereby making the mould be fast assembled. Moreover, the flat thimble cannot be blocked during the inserting, so that the front portion thereof and the inner walls of the through hole cannot be scratched and life of the mould can be elongated.

### BRIEF DESCRIPTION OF THE DRAWINGS

FIG. 1 is a perspective view of a mould with flat thimble according to one embodiment of the present invention;

FIG. 2 is an inner structure view of the mould with flat thimble of FIG. 1;

FIG. 3 is an inner structure view of a guide plate according to one embodiment of the present invention; and

FIG. 4 is an inner structure view of a guide plate according to another embodiment of the present invention.

### DETAILED DESCRIPTION OF THE PREFERRED EMBODIMENTS

The following embodiment with reference to the accompanying drawings now has been given for detail describing the technology, the feature, the object and the effect of the present invention.

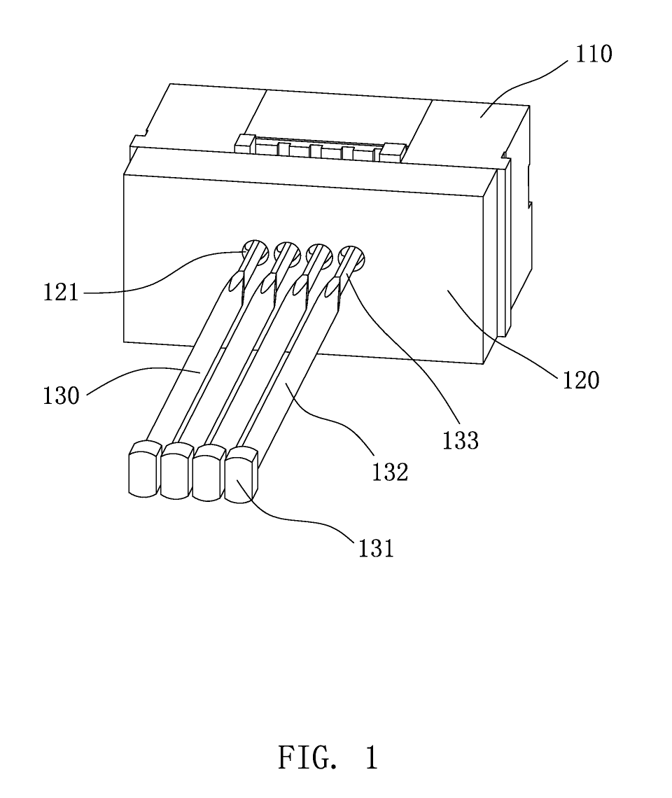

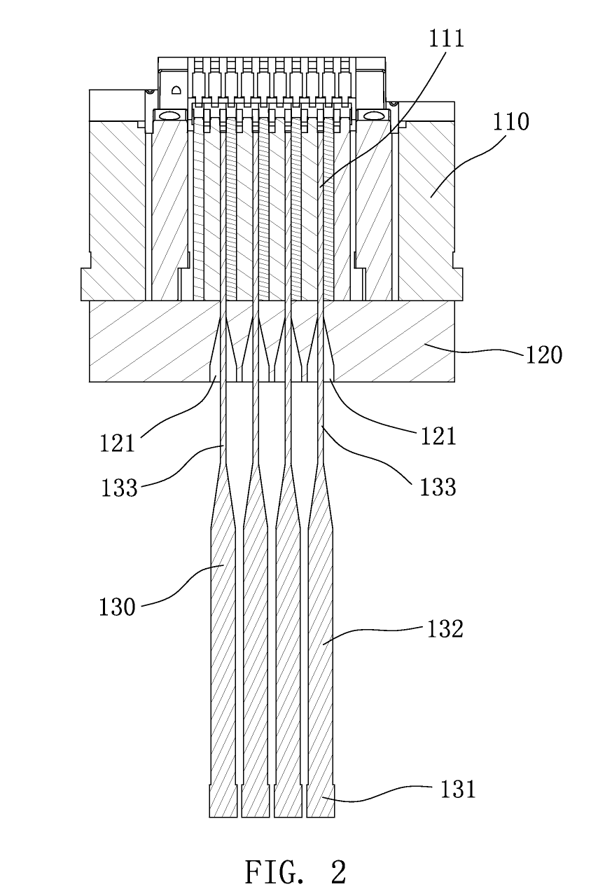

Please refer to FIGS. 1 and 2, a mould with flat thimble of the present invention comprises a mould core 110, a guide plate 120 and a flat thimble 130. The guide plate 120 is fixedly mounted on one end of the mould core 110. The flat thimble 130 partly passes through the guide plate 120 and is received in the mould core 110.

Wherein, the mould core 110 forms a mould cavity (not shown in all FIGS), in which the product of injection molding is formed. The mould core 110 disposes at least one groove 111, which is communicated with the mould cavity and can receive the flat thimble 130.

The flat thimble 130 includes a bottom portion 131, a post portion 132 and a front portion 133. A cross-sectional area of the bottom portion 131 is larger than that of the post portion 132, so that the stressed area of the flat thimble 130 can be enlarged for conveniently pushing out the product of injection molding and for preventing the flat thimble 130 from being destroyed. Two ends of the post portion 132 are separately connected to the bottom portion 131 and the front portion 133. The front portion 133 is extended from the post portion 132 and is away from the bottom portion 131. The front portion 133 is slim and flat, and can partly pass through the guide plate 120 to be received in the groove 111 of the mould core 110. The front portion 133 can slide forward and backward in the groove 111 for being close to the mould cavity and pushing out the product under the action of the external force.

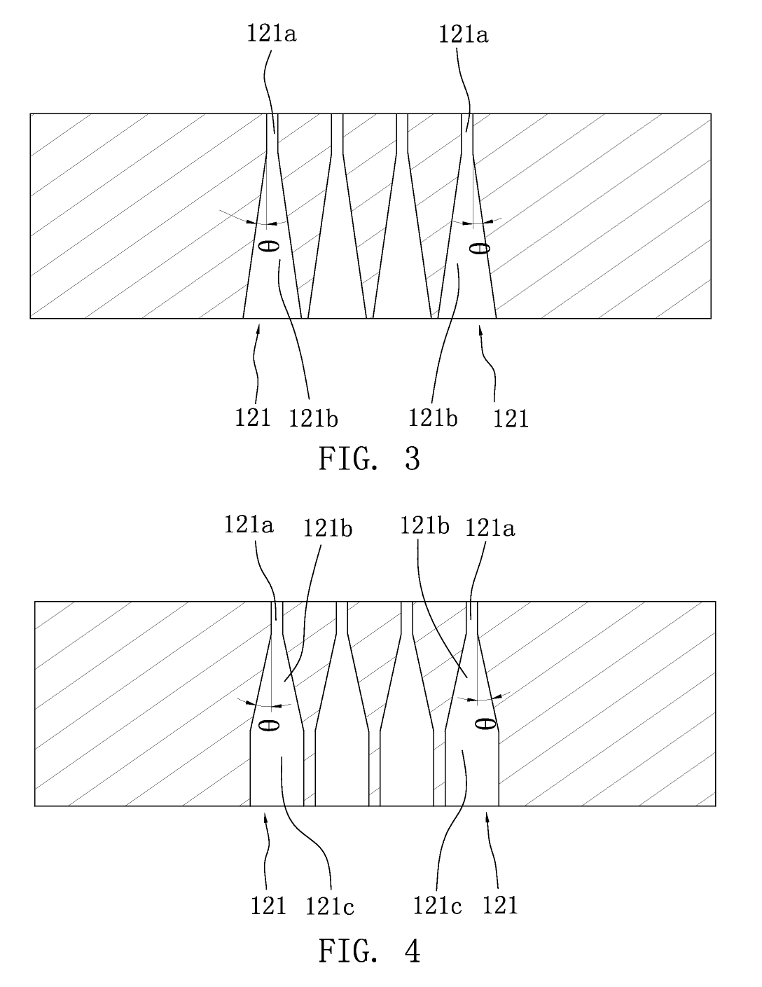

Referring to FIG. 3, which is an inner structure view of the guide plate 120 according to a first embodiment of the present invention, the guide plate 120 forms at least one through hole 121, which is passing through a front surface and a back surface of the guide plate 120. The through hole 121 mainly includes a communicating section 121a and a guiding section 121b. The communicating section 121a has a pore diameter suitable for accepting the front portion 133 of the flat thimble 130 and is communicated with the groove 111 of the mould core 110. The guiding section 121b is expanded from one end of the communicating section 121a along away from the groove 111. A connecting section connecting the communicating section 121a and the guiding section 121b forms an inclination angle θ with respect to said longitudinal axis of the through hole 121, and the inclination angle θ may be 5 degrees. Therefore, the pore diameter of the guiding section 121b is more and more large from the communicating section 121a and is larger than that of the communicating section 121a, so that the front portion 133 of the flat thimble 130 can be fast and conveniently inserted into the guiding section 121b and can pass through the communicating section 121a to be close to the mould cavity. The connecting section of the guiding section 121b and the communicating section 121a is a smooth surface, so that the flat thimble 130 can be smoothly inserted into the communicating section 121a along the inner wall of the guiding section 121b during the inserting course. Therefore, the front portion 133 of the flat thimble 130 can not be bumped on the inner wall of the communicating section 121a, and the front portion 133 of the flat thimble 130 and the inner wall of the communicating section 121a can avoid to be destroyed.

Referring to FIG. 4, which is an inner structure view of the guide plate 120 according to a second embodiment of the present invention, the difference between the guide plates 120 of the first and second embodiments is that the guide plate 120 of the first embodiment further has an extending section 121c, which is extending from the guiding section 121b along away from the communicating section 121a. The pore diameter of the extending section 121c is same as the largest pore diameter of the guiding section 121b, so that the front portion 133 of the flat thimble 130 can be conveniently inserted into and pass through the communicating section 121a. When mounting the flat thimble 130, the front portion 133 thereof orderly passes through the extending section 121c, the guiding section 121b and the communicating section 121a to be received in the groove 111 of the mould core 110. Moreover, the cooperating and connecting relationship between the flat thimble 130, the through hole 121 of the guide plate 120 and the groove 111 of the mould core 110 in the second embodiment is completely same as that of the first embodiment, so there's no need to repeat.

As described above, the flat thimble 130 can be fast and simply mounted to the mould of the prevent invention. During the course of inserting, the front portion 133 of the flat thimble 130 can not be destroyed and can not scratch the inner wall of the through hole 121 of the guide plate 120, so that elongating life of the mould.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A mould with flat thimble comprising:
a mould core, disposing a groove;
a guide plate, being fixedly connected to one end of the mould core and forming a through hole corresponding to the groove; and
a flat thimble, partly passing through the through hole to be received in the groove;
wherein the through hole includes a communicating section and a guiding section expanded from one end of the communicating section along away from the groove, a pore diameter of the guiding section is larger than that of the communicating section, and the flat thimble partly passes through the communicating section and the guiding section to be received in the groove.

2. The mould with flat thimble as claimed in claim 1, wherein a connecting section connecting the guiding section and the communicating section is a smooth surface.

3. The mould with flat thimble as claimed in claim 1, wherein a connecting section connecting the guiding section and the communicating section forms an inclination angle.

4. The mould with flat thimble as claimed in claim 3, wherein the inclination angle is 5 degrees.

5. The mould with flat thimble as claimed in claim 1, wherein the through hole further includes an extending section, which is extending from the guiding section along away from the communicating section.
